(19) United States
(12) Patent Application Publication
(10) Pub. No.: US 2002/0021820 A1
(43) Pub. Date: Feb. 21, 2002

(54) Loudspeaker

(76) Inventor: Brian Mitchell, Southport (GB)

Correspondence Address: THOMPSON HINE L.L.P., 2000 COURTHOUSE PLAZA , N.E., 10 WEST SECOND STREET, DAYTON, OH, 45402, US

(21) Appl. No.: 09/921,043

(22) Filed: Aug. 2, 2001

(30) Foreign Application Priority Data
Aug. 2, 2000 (GB) 0018831.8

(51) Int. Cl. H04R 25/00

(52) U.S. Cl. 381/424; 381/398

(57) ABSTRACT

A low frequency loudspeaker comprises a conventional electromagnetic cone driver 4 having a cone diaphragm 9 provided with an inner suspension 8 and a role surround 12. The cone diaphragm 9 is connected, between the suspensions 8 and 12, to a flat diaphragm 11 whose ends are mechanically terminated so as not to be entirely free to move.

### BACKGROUND OF THE INVENTION

1. Field of the Invention

The present invention relates to a low frequency loudspeaker. Such a loudspeaker may be used, for example, as part of a system covering the audible frequency range for domestic or professional applications.

2. Description of the Prior Art

As is well known in the field of loudspeaker design, in order to produce acceptable output at low frequencies, for example in the range from about 50 Hz to about 200 Hz, it is necessary to prevent the acoustic energy generated by the rear of a cone diaphragm of an electromagnetic driver from interfering destructively with the acoustic output from the front of the cone diaphragm. One technique for achieving this involves mounting the driver on a large baffle so as to increase the acoustic path length of acoustic radiation from the rear of the cone diaphragm to the front thereof. Another known technique involves mounting the driver in an enclosure which may or may not be sealed. Such enclosures generally contain material for at least partially damping the acoustic output from the rear of the cone diaphragm.

Although these known measures allow the low frequency output of the loudspeaker to be extended, such arrangements are generally large and heavy. Also, the resulting desired acoustic output tends to be subjected to “colourations”, for example substantial variations in the frequency response. Reducing the size of an enclosure also reduces the electro-acoustic efficiency at relatively low frequencies.

GB 375 598 discloses a loudspeaker driver of the moving coil type in which a single voice coil in a magnetic gap drives the smaller end of a first frustoconical diaphragm. The outer end of the first diaphragm is resiliently coupled to the middle part of a second larger frustoconical diaphragm which is concentric with and surrounds the first diaphragm. It is suggested that the resilient coupling may be arranged such that the second diaphragm only responds to lower frequencies. Such a driver requires an enclosure in order to reproduce lower frequencies but there is no disclosure of an enclosure in this document.

GB 665 815 discloses a loudspeaker driver having separate bass and treble frustoconical diaphragms with the treble diaphragm arranged concentically within the bass diaphragm. Each diaphragm is connected at its smaller end to a respective voice coil. The coils are located in respective magnetic gaps with the outer polepiece for the treble coil forming the inner polepiece for the bass coil. Again, such a driver requires an enclosure in order to reproduce lower frequencies adequately but no details are given.

### SUMMARY OF THE INVENTION

According to the invention, there is provided a low frequency loudspeaker comprising: a driver having a cone diaphragm with an inner suspension and an outer suspension; and a further diaphragm mechanically connected to the cone diaphragm between the inner and outer suspensions and having an edge which is mechanically terminated, the further diaphragm being substantially flat, having an aperture for the passage of acoustic energy from the cone diaphragm and extending laterally outwardly of the cone diaphragm.

The term “mechanically connected” as used herein refers to a connection in which momentum is at least partially transmitted through and by means of a connection. The term “mechanically terminated” as used herein means not completely free to move without constraint. Mechanical termination thus partly or completely restricts or reduces movement.

The further diaphragm may be substantially flat.

The mechanical termination may be a substantially rigid termination or may be a resilient termination.

The mechanical connection between the cone diaphragm and the further diaphragm may be substantially rigid. The cone diaphragm may be directly connected to the further diaphragm or may be connected by a substantially rigid intermediate member.

The mechanical connection between the cone diaphragm and the further diaphragm may be resilient and may be by a resilient intermediate member.

The intermediate member may be annular.

The intermediate member may be of a cellular material, for example polystyrene foam.

The cone diaphragm may be connected to the further diaphragm substantially at or adjacent the edge of the aperture.

The cone diaphragm may be connected to the further diaphragm adjacent the outer suspension.

The inner and outer suspensions may be connected to the cone diaphragm at inner and outer, edges respectively, of the cone diaphragm.

The further diaphragm may be made of a laminar material, which may be a plastics material and which may comprise first and second layers connected together by a corrugated layer.

The further diaphragm may have a lateral dimension which is substantially equal to or greater than twice a lateral dimension of the cone diaphragm. The lateral dimension of the further diaphragm may be less than three times the lateral dimension of the cone diaphragm.

The further diaphragm may be substantially rectangular and may be mechanically terminated at its edge by a substantially rectangular frame having inside corners which are rounded in a transverse plane.

The driver may comprise an electromagnetic motor for driving the cone diaphragm. The driver may comprise a chassis defining a substantially frusto conical volume in which the motor is disposed.

It is thus possible to provide a low frequency loudspeaker which is capable of producing a relatively smooth and uncoloured acoustic output at low frequencies without requiring a large baffle or a large and/or heavy enclosure. Furthermore, this may be achieved with an acceptable electro-acoustic efficiency. Such a loudspeaker is suitable for use, for example, as a “woofer” in a loudspeaker system for domestic use. However, such a loudspeaker is also suitable for use in professional applications, such as public address or sound reinforcement systems and is capable of providing a high level of relatively low frequency acoustic output at relatively high electro-acoustic efficiency. It is further possible to provide a low frequency loudspeaker having an extended upper frequency range and operation from about 50 Hz to about 2000 Hz is believed possible.

The invention will be further described, by way of example, with reference to the accompanying drawings, in which:

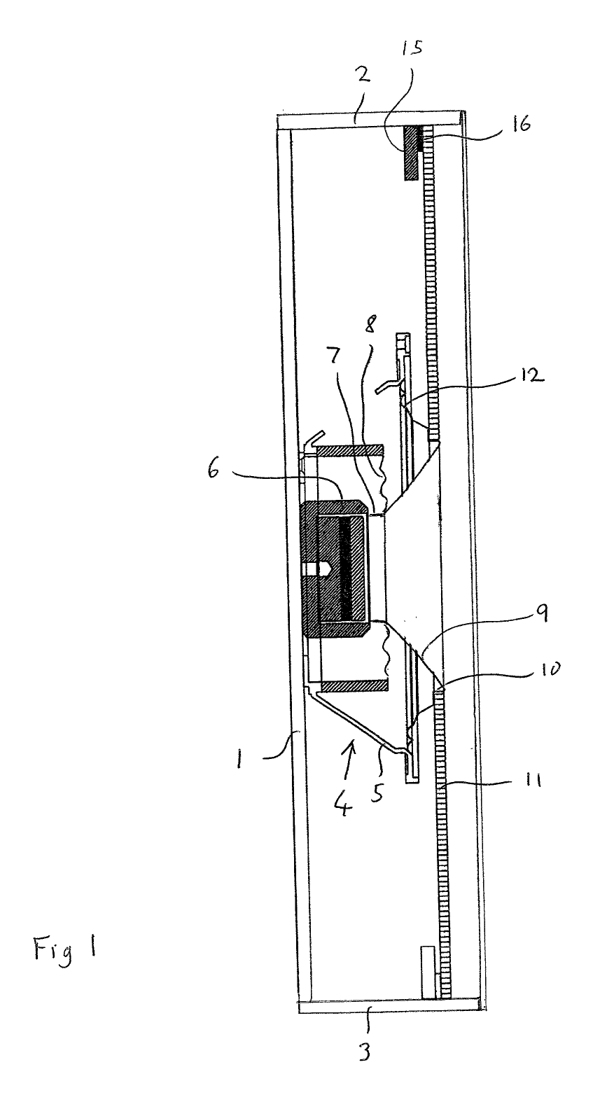

FIG. 1 is a vertical cross-sectional view of a low frequency loudspeaker constituting an embodiment of the invention;

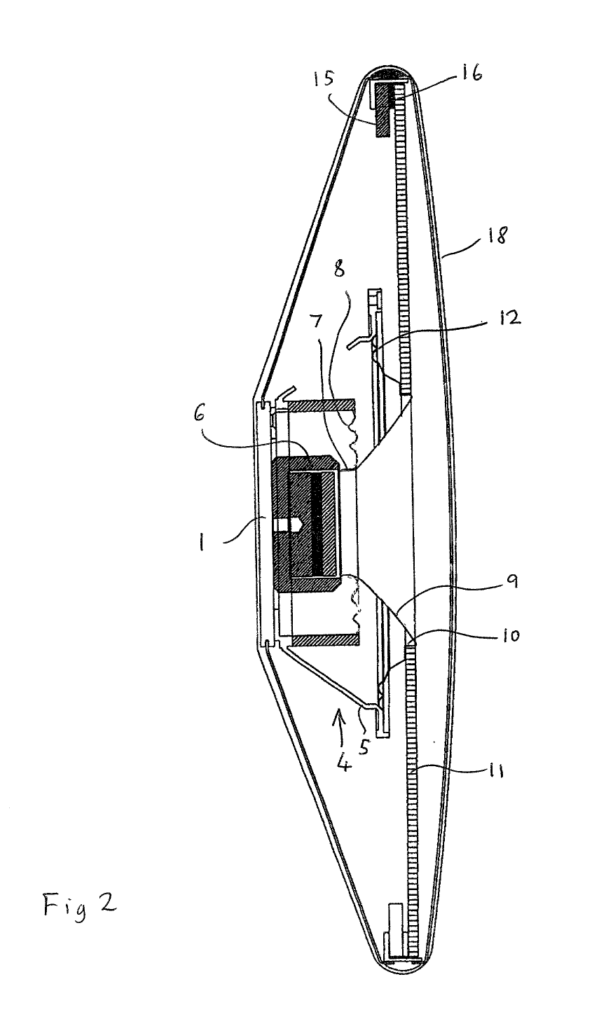

FIG. 2 is a horizontal cross-sectional view of the loudspeaker of FIG. 1;

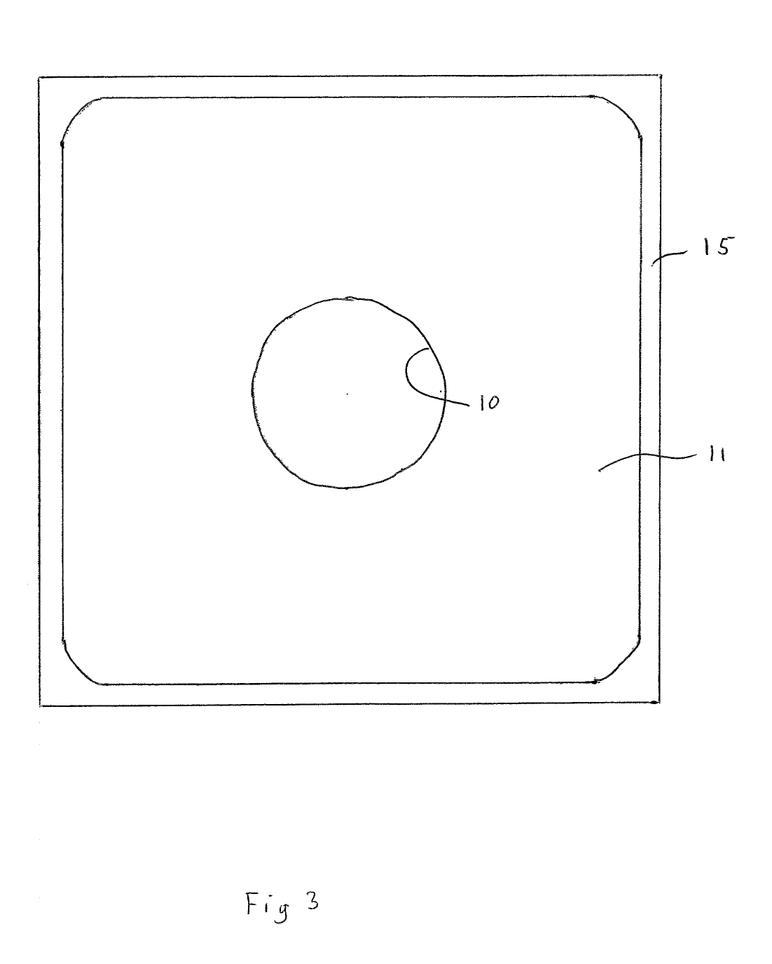

FIG. 3 is a front view of part of the loudspeaker of FIG. 1; and

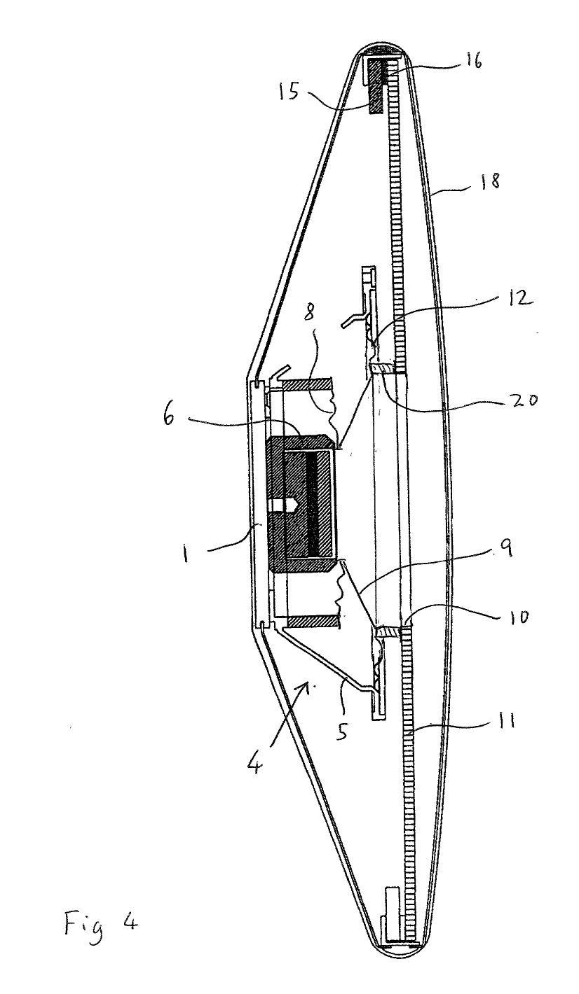

FIG. 4 is a horizontal cross-sectional view of a loudspeaker constituting a further embodiment of the invention.

Like reference numerals refer to like parts throughout the drawings.

The loudspeaker shown in FIGS. 1 and 2 comprises a supporting frame having a vertical plate 1 rigidly connected to top and bottom plates 2 and 3. An electromagnetic moving coil driver 4 is fixed to the plate 1 and comprises a chassis 5 which defines a frusto conical volume containing a motor 6. The motor is of conventional type and comprises a permanent magnet with a centre pole piece and annular outer pole piece defining an annular magnetic gap. A voice coil wound on a former is disposed in the magnetic gap.

The former extends forwardly of the magnetic gap as illustrated at 7 and is held in place transversely with respect to the axis of the driver by an inner suspension 8, which allows the voice coil 7 to move longitudinally with respect to the driver axis. The front of the voice coil 7 is fixed to the inner end of a cone diaphragm 9, for example made of paper, plastics, or a composite material.

The outer edge of the cone diaphragm 9 is fixed, for example by means of an adhesive, to the edge 10 of an aperture formed in a further diaphragm 11. The edge 10 of the aperture is also fixed to an outer suspension or roll surround 12. The suspensions 8 and 12 provide a restoring force which urges the voice coil on the former 7 to a rest position which is longitudinally substantially centred in the magnetic gap of the motor 6.

The further diaphragm 11 is made of a relatively light material having a degree of rigidity which makes it substantially capable of performing pistonic movement but with a degree of flexibility such that the amount of movement reduces with distance from the aperture. For example, the further diaphragm 11 may be made of a laminar plastics material of a type known as Corex (TM), which comprises first and second plastics layers connected together by a corrugated plastics layer.

The cone diaphragm 9 typically has a diameter which is nominally between about 6 inches (about 15 cm) and about 18 inches (about 45 cm). The further diaphragm 11 may have any desired shape but the example illustrated in the drawings is square. In the case of a “10 inch” cone driver 4, each side of the further diaphragm 11 is 22 inches (about 55 cm) in length. In general, it is believed that the lateral dimension of the further diaphragm 11 should be about twice that of the cone diaphragm 9 or perhaps a little more. It may be preferable for the lateral dimension of the further diaphragm 11 to be less than three times the lateral dimension of the cone diaphragm 9. However, these relative dimensions may depend on various factors, for example the properties of the material of which the further diaphragm 11 is made.

The edges of the further diaphragm 11 are mechanically terminated by being connected to a rectangular frame 15, which is fixed to the top and bottom plates 2 and 3. As shown in FIG. 3, the inner corners of the frame 15 are rounded. The connection between the edges of the further diaphragm 11 and the frame 15 may be direct, for example by means of adhesive, or maybe via an intermediate member as illustrated at 16. The termination may be rigid such that the edges of the further diaphragm 11 are substantially prevented from moving. Alternatively, the connection may have at least some degree of resilience so as to permit some movement of the edges of the further diaphragm 11. The intermediate member 16 may be of any suitable material, depending on the specific requirements of the embodiment, and an example of a material which is suitable for some applications is polystyrene foam.

In use, the voice coil on the former 7 of the driver 4 is connected to a suitable voltage source, for example the output of a power amplifier (directly or via a “crossover filter”) and performs substantially pistonic motion within the magnetic gap of the motor 6. This movement is transmitted directly to the conical diaphragm 9, which ideally also performs pistonic movement although, in practice, pure pistonic movement cannot generally be achieved throughout a desired frequency range of operation. The outer edge of the cone diaphragm 9 transmits the movement to the further diaphragm 11. Thus, substantially the whole front of the loudspeaker is an acoustically radiating surface. It has been found that this arrangement provides good low frequency extension and, in particular, permits a low frequency loudspeaker to be produced without requiring an enclosure or a large baffle. The loudspeaker may therefore be relatively compact and relatively light, thus easing handling. Also, colourations associated with enclosures are substantially eliminated so that high quality low frequency sound may be produced.

The frame comprising the vertical plate 1 and the top and bottom plates 2 and 3 support the loudspeaker but do not perform any substantial acoustic function. FIG. 2 illustrates a cover or sleeve 18 which visually encloses the elements of the loudspeaker but which is acoustically substantially transparent. The sleeve 18 performs protective and decorative functions but does not perform any substantial acoustic function and, in particular, does not act as an enclosure.

The loudspeaker shown in FIG. 4 differs from that shown in FIGS. 1 and 2 in that the cone diaphragm 9 is connected to the further diaphragm 11 at or adjacent the edge 10 of the aperture therein by an intermediate member 20. The intermediate member 20 is annular and provides a rigid or resilient connection between the cone diaphragm 9 and the further diaphragm 11. An example of a suitable material for the intermediate member 20 is polystyrene foam.

Various factors determine the performance achieved by the loudspeaker. These include the sizes of the cone diaphragm 9 and the further diaphragm 11, the properties of the materials of the diaphragms, the degree of resilience in the connection between the cone diaphragm 9 and the further diaphragm 11, and the degree of resilience in the mechanical termination of the edges of the further diaphragm 11. For example, it has been found that a relatively rigid connection between the diaphragms 9 and 11 and a relatively rigid termination of the edges of the further diaphragm 11 provide better high frequency extension and a better transient performance. For example, it may be possible to achieve operation in a frequency range extending to about 2000 Hz. More resilience in the connection and/or in the edge termination tends to decrease the high frequency extension and to reduce the low frequency transient response but provides a more extended low frequency response. The material of the further diaphragm 11 is required to have a sufficient degree of mechanical stability while being sufficiently resilient to allow the inner portions of the further diaphragm 11 to move further than the outer portions or the edge. The mechanical properties of the further diaphragm 11 may thus be varied to allow further “tuning” of the sound produced by the loudspeaker.

The driver 4 is illustrated as having the motor 6 within the frusto conical volume defined by the chassis 5 and this gives a relatively compact arrangement. However, conventional drivers in which the motor extends to the rear of the chassis may also be used.

It is thus possible to provide a low frequency loudspeaker which dispenses with the need for large baffles and any type of enclosure. Colourations associated with enclosures may thus be reduced or substantially eliminated and a relatively compact and light-weight arrangement may be provided for convenience of handling, for example in the case of a public address system, and for convenience of location, for example in a domestic environment. The electro-acoustic efficiency is acceptable and may be comparable to conventional arrangements so that no unusual power amplifier drive capabilities are required. The loudspeaker may thus be readily incorporated into a full-range multiple loudspeaker system, for example comprising in addition one or more high frequency loudspeakers or “tweeters” and one or more mid-range loudspeakers. Such a loud speaker is capable of covering the same range of frequencies as a conventional type of low frequency loudspeaker, for example from about 50 Hz to about 200 Hz, but may be capable of a more extended high frequency response, perhaps to as much as 2000 Hz.

1. A low frequency loudspeaker comprising: a driver having a cone diaphragm with an inner suspension and an outer suspension; and a further diaphragm mechanically connected to said cone diaphragm between said inner and outer suspensions and having a first edge which is mechanically terminated, said further diaphragm being substantially flat, having a second edge defining aperture for passage of acoustic energy from said cone diaphragm and extending laterally outwardly of said cone diaphragm.

2. A loudspeaker as claimed in claim 1, in which said first edge has a mechanical termination which is substantially rigid.

3. A loudspeaker as claimed in claim 1, in which said first edge has a mechanical termination which is resilient.

4. A loudspeaker as claimed in claim 1, comprising a mechanical connection between said cone diaphragm and said further diaphragm which is substantially rigid.

5. A loudspeaker as claimed in claim 4, in which said cone diaphragm is directly connected to said further diaphragm.

6. A loudspeaker as claimed in claim 4, in which said cone diaphragm is connected to said further diaphragm by a substantially rigid intermediate member.

7. A loudspeaker as claimed in claim 1, comprising a mechanical connection between said cone diaphragm and said further diaphragm which is resilient.

8. A loudspeaker as claimed in claim 7, in which said cone diaphragm is connected to said further diaphragm by a resilient intermediate member.

9. A loudspeaker as claimed in claim 6, in which said intermediate member is annular.

10. A loudspeaker as claimed in claim 8, in which said intermediate member is annular.

11. A loudspeaker as claimed in claim 10, in which said intermediate member is made of a cellular material.

12. A loudspeaker as claimed in claim 1, in which said cone diaphragm is connected to said further diaphragm adjacent said second edge.

13. A loudspeaker as claimed in claim 1, in which said cone diaphragm is connected to said further diaphragm adjacent said outer suspension.

14. A loudspeaker as claimed in clam 1, in which said inner and outer suspensions are connected to said cone diaphragm at inner and outer edges, respectively, of said cone diaphragm.

15. A loudspeaker as claimed in claim 1, in which said further diaphragm is made of a laminar material.

16. A loudspeaker as claimed in claim 15, in which said laminar material comprises first and second layers connected together by a corrugated layer.

17. A loudspeaker as claimed in claim 15, in which said laminar material is a plastics material.

18. A loudspeaker as claimed in claim 1, in which said further diaphragm has a lateral dimension which is substantially equal to or greater than twice a lateral dimension of said cone diaphragm.

19. A loudspeaker as claimed in claim 18, in which said lateral dimension of said further diaphragm is less than three times said lateral dimension of said cone diaphragm.

20. A loudspeaker as claimed in claim 1, in which said further diaphragm is substantially rectangular and is mechanically terminated at said first edge by a substantially rectangular frame having inside corners which are rounded in a transverse plane.

21. A loudspeaker as claimed in claim 1, in which said driver comprises an electromagnetic motor for driving said cone diaphragm.

22. A loudspeaker as claimed in claim 21, in which said driver comprises a chassis defining a substantially frustoconical volume in which said motor is disposed.
